(19) United States
(12) Patent Application Publication
(10) Pub. No.: US 2011/0163693 A1
(43) Pub. Date: Jul. 7, 2011

(54) CIRCUIT ARRANGEMENT AND METHOD FOR OPERATING AT LEAST ONE LED

(75) Inventors: Ralf Hying, Munchen (DE); Peter Niedermeier, Muenchen (DE); Oskar Schallmoser, Ottobrunn (DE)

(73) Assignee: OSRAM GESELLSCHAFT MIT BESCHRAENKTER HAFTUNG, Muenchen (DE)

(21) Appl. No.: 13/003,003

(22) PCT Filed: Jul. 7, 2008
(86) PCT No.: PCT/EP08/58753

§ 371 Date: Feb. 23, 2011

(51) Int. Cl. H05B 37/02

(52) U.S. Cl. 315/297

(57) ABSTRACT

A circuit arrangement for operating at least one LED may include an operational amplifier; wherein a first connection of the LED is coupled to a connection for a DC supply voltage; a transistor which is coupled in series with the first connection and a second connection for the LED and can be operated in an analog manner, wherein the transistor has a control electrode, a reference electrode and a working electrode, wherein the control electrode is coupled to the output of the amplifier, wherein the working electrode is coupled to the connection for a supply voltage; and a current measuring resistor which is coupled in series between the reference electrode and a reference potential, wherein the voltage dropped across the current measuring resistor is coupled to the inverting input of the amplifier; wherein at least one load is coupled in parallel with the first and second connections for the LED.

### TECHNICAL FIELD

The present invention relates to a circuit arrangement for operating at least one LED, having an operational amplifier with a non-inverting input and an inverting input as well as an output, a desired value predefining apparatus which is coupled to the non-inverting input of the operational amplifier, a first connection and a second connection for the at least one LED, wherein the first connection is coupled to a connection for a DC supply voltage, a transistor which is coupled in series with the first and second connections for the at least one LED and can be operated in an analog manner, wherein the transistor has a control electrode, a reference electrode and a working electrode, wherein the control electrode of the transistor is coupled to the output of the operational amplifier, wherein the working electrode of the transistor is coupled to the connection for a DC supply voltage, and a current measuring resistor which is coupled in series between the reference electrode of the transistor and a reference potential, wherein the voltage dropped across the current measuring resistor is coupled to the inverting input of the operational amplifier. The invention also relates to a corresponding method for operating at least one LED.

### PRIOR ART

A generic circuit arrangement, known from the prior art, is shown in FIG. 1. A desired value predefining apparatus 10 provides a nominal voltage Uₛₒₗₗ at its output, which is coupled to the non-inverting input of an operational amplifier 12. The operational amplifier 12 is supplied from a first source +V_{cc}, which provides a positive DC supply voltage, and from a second source Vₛₛ, which provides a supply voltage of zero or a negative DC supply voltage. A feedback network is connected between the output A of the operational amplifier 12 and its inverting input, and here includes the series circuit of an ohmic resistor R1 and a capacitor C1. The voltage dropped between the non-inverting input and the inverting input of the operational amplifier 12 is denoted by U_{Diff}. The output A of the operational amplifier 12 is connected to the control input, here the gate connection, of a transistor T1. An LED is connected between a DC supply voltage V₋, which can correspond to the source +V_{cc}, and the working electrode, here the drain connection, of the transistor T1, over which a voltage U_{LED} drops. A current measuring resistor Rₛₕᵤₙₜ is arranged between the reference electrode, here the source connection, of the transistor T1 and a reference potential, over which a voltage Uₛₕᵤₙₜ drops. The voltage Uₛₕᵤₙₜ is likewise connected via a second ohmic resistor R2 to the inverting input of the operational amplifier 12. The operational amplifier 12 forms a linear regulator together with its feedback and the transistor T1.

Generic circuit arrangements are used, for example, in LED projection applications, in particular in so-called back projection. Signals are applied from the desired value predefining apparatus to the operational amplifier, which may have very short turn-on pulses, up to 4 μs, and very short dark periods, likewise up to 4 μs. As corresponding analyses have shown, operation of the generic circuit arrangements was unsatisfactory in particular in the case of very short turn-on pulses or dark periods. This leads to projection results of lower quality.

### REPRESENTATION OF THE INVENTION

The object of the present invention is therefore to develop a circuit arrangement described in the introduction or a method described in the introduction such that higher quality projection applications are made possible.

This object is achieved by a circuit arrangement with the features of claim 1 and a method with the features of claim 6.

The present invention is based on the understanding that within the entire current range which can flow through the LED and which ranges from 0 A to I_{LEDmax}, at a specified current in the range of 0 A, the linear regulator has undesirable, strongly deteriorating properties. The reason for this is that in practice it is never possible to control a current of 0 A with complete precision, i.e. positive or negative current, even if very low, always flows. As the circuit arrangement used permits no negative currents at all, in this case the operational amplifier would saturate and abandon linear regulator operation. As a result, the control characteristics would deteriorate inadmissibly greatly. The regulator therefore displays various dynamic behavior within the entire current range. A detailed analysis of the processes with currents close to 0 A can be found below, reference being made to FIG. 3.

As a result of at least one other load being connected in parallel to the LED, at appropriate dimensioning the voltage over the LED remains so low that the LED still does not emit light, although the analog transistor is already in linear operation, as a positive control voltage is applied to it. The transistor can be switched on quickly so that a time lag is avoided by the slew rate of the analog-operable transistor. As a result extremely short turn-on pulses and dark periods can be achieved, resulting in very high-quality projection applications.

In the circuit arrangement according to the invention an LED can therefore be operated regardless of manufacturer or color or manufacturing lot such that it does not yet light up at a specified current of 0 A, but the current regulator is already operative, i.e. in linear operation. At now predefined current steps the regulator can react with extremely small time constants.

A further advantage of having at least one load connected to an LED in parallel is that this results in the discharge of the capacity of the LED and its cables after the current through the LED has been switched off. This avoids an after-glow of the LED, which in the prior art may be up to 1 μs. Furthermore, negative current spikes on account of line inductivities, which may be up to 1 V and can therefore result in the failure of the LED, are reliably eliminated.

Preferably the load connected to at least one LED in parallel represents at least one or more elements of the following selection: ohmic resistor, current sink, constant-current diode.

It is particularly preferable that the load includes at least one first and one second partial load, an electronic switch being assigned in series to at least the second partial load. This opens up the possibility of changing the load as a function of the color emitted by the LED or to take manufacturing tolerances into consideration, in order to take account of different cut-off voltages. By this means the current as of which the LED emits light can be selected. Ageing of the LED or a change in the temperature of the LED, for example, can also be taken into account in this way.

Furthermore, it is particularly preferable that the circuit arrangement includes a microcontroller which is designed to determine the forward voltage of at least one LED coupled between the first and the second connection for the at least one LED and to control the electronic switch(es) accordingly. This opens up the possibility of always automatically connecting the most appropriate load or the most appropriate loads of the at least one LED in parallel, i.e. in particular, also dynamically during operation of the at least one LED.

Furthermore, it is preferable if a feedback network is connected between the output and the inverting input of the operational amplifier. By this means the control parameters of the linear regulator and consequently the circuit arrangement can be selected.

Further advantageous embodiments emerge from the subclaims.

The preferred embodiments and their advantages presented in connection with a circuit arrangement according to the invention apply accordingly, insofar as applicable, to the method according to the invention.

In a preferred embodiment of the method according to the invention the step of coupling takes place such that as a result when operating the circuit arrangement a positive current constantly flows through the at least one LED.

### BRIEF DESCRIPTION OF THE DRAWING(S)

We will now describe in more detail an exemplary embodiment of a circuit arrangement according to the invention with reference to the attached drawings. These show:

FIG. 1 in schematic representation a circuit arrangement for operating at least one LED known from the prior art;

FIG. 2 in schematic representation an exemplary embodiment of a circuit arrangement according to the invention; and

FIG. 3 the chronological sequence of various variables of the circuit arrangements of FIG. 1 and FIG. 2.

### PREFERRED EMBODIMENT OF THE INVENTION

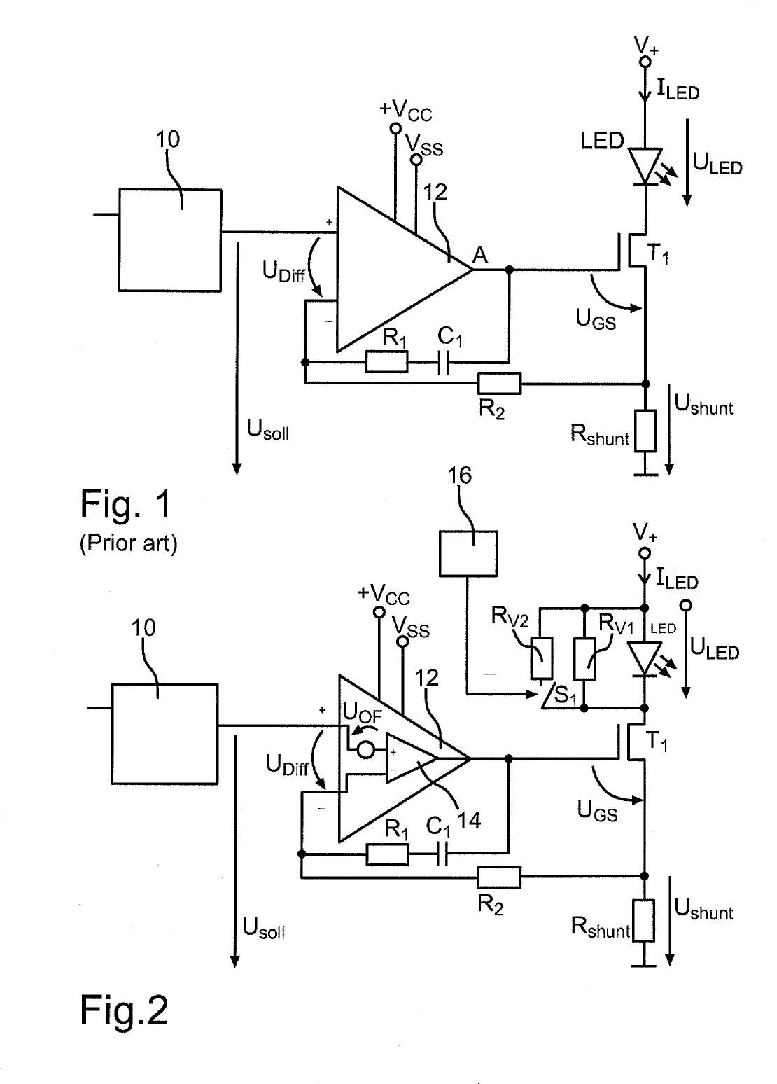

The reference characters inserted with reference to FIG. 1 apply accordingly to identical or similar components of the exemplary embodiment of the invention represented in FIG. 2. They will not be inserted again.

In FIG. 2 the operational amplifier 12 is shown in more detail. In particular, a voltage source U_{OF} is included between the non-inverting input of the operational amplifier 12 and the non-inverting input of an ideal operational amplifier 14 included in the operational amplifier 12, which reproduces the so-called offset voltage. Depending on the manufacturing lot or the ageing status or other parameters, the offset voltage U_{OF} may be positive or negative. It is not critical if the differential voltage U_{Diff} between the positive and the negative input of the operational amplifier 12 is positive, i.e. the offset voltage U_{OF} is positive. If namely the current I_{LED} is close to zero, the voltage Uₛₕᵤₙₜ dropped at the current measuring resistor Rₛₕᵤₙₜ is almost zero, but positive. At output A of the operational amplifier 12 a small, positive voltage is applied to the control electrode of the transistor T1. As a result the transistor T1 remains conductive and can if necessary enable the current to increase again quickly. However, the LED illuminates undesirably.

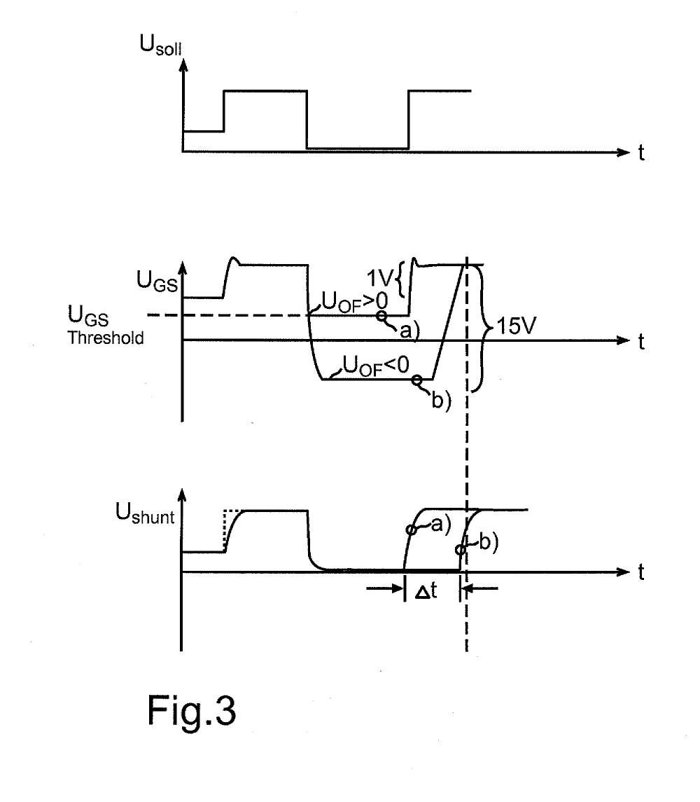

However, it is even more critical if the offset voltage U_{OF} is negative. For clarification, reference is made to the chronological sequences of the voltage Uₛₒₗₗ, U_{GS} and Uₛₕᵤₙₜ in FIG. 3. At the top the chronological sequence of the nominal voltage U_{Soll} is shown, which can be square for example, a curved line a) showing the chronological sequence in the event that U_{OF} is greater than zero, and a curved line b) showing the chronological sequence in the event that U_{OF} is less than zero. The processes for U_{OF} greater than zero have already been mentioned. If U_{OF} is less than zero, a negative voltage is applied at output A of the operational amplifier 12. The operational amplifier 12 “wants” to regulate in such a way that the voltage Uₛₕᵤₙₜ at the current measuring resistor Rₛₕᵤₙₜ becomes negative. This is not possible as the transistor T1 can no longer be set to a non-conductive status. This results in no further closed-loop system being available. The voltage at output A of the operational amplifier falls to Vₛₛ, where Vₛₛ may be zero or less than zero. In a preferred exemplary embodiment Vₛₛ is −15 V and is not shown to scale in FIG. 3 for the sake of clarity.

If the operational amplifier 12 is now to be moved out of this position again into an area with positive current I_{LED}, the operational amplifier 12 initially finds itself “so affected”, i.e. in such a saturated condition, that dynamically it is very slow. This is shown by the curved line at the bottom of FIG. 3: curved line a) corresponds to curved line a) in the middle diagram, while curved line b) corresponds to curved line b) in the middle diagram. As shown, the voltage Uₛₕᵤₙₜ only rises with a significant time lag Δt, if U_{OF} is negative and the operational amplifier 12 has been operated in a phase with a current I_{LED} close to 0 A. This time lag results in turn-on pulses and dark periods of short duration not being reproduced at all or inaccurately, in particular being much too short. This is particularly evident when it is recalled that Δt may be as much as 10 μs or more.

Increasing the voltage Uₛₒₗₗ such that it is always greater than U_{OF}, regardless of whether U_{OF} is positive or negative, would result in U_{GS} always being greater than zero and thus a current flow I_{LED} takes place through the LED, even if this is not desired. In order to prevent this, see FIG. 2, it is now envisaged in accordance with the invention to connect at least one load R_{V1} to the LED in parallel. Preferably further loads are envisaged, of which one in FIG. 2, namely the load R_{V2}, is shown by way of example. In series with these loads a switch, here the switch S1, is preferably arranged, which is operated by a microcontroller 16. The microcontroller 16 is designed to determine the flow voltage of the LED and to control the switch S1 such that overall the appropriate total load resistance of the LED is always connected in parallel. Appropriate here means that the threshold voltage of the LED, i.e. the voltage as of which the LED emits light, is just undershot thanks to the use of the parallel connection of one or more additional loads.

1. A circuit arrangement for operating at least one light emitting diode, the circuit arrangement comprising:
an operational amplifier with a non-inverting input and an inverting input as well as an output;
a desired value predefining apparatus which is coupled to the non-inverting input of the operational amplifier;
a first connection and a second connection for the at least one light emitting diode, wherein the first connection is coupled to a connection for a DC supply voltage;
a transistor which is coupled in series with the first and second connections for the at least one light emitting diode and can be operated in an analog manner, wherein the transistor has a control electrode, a reference electrode and a working electrode, wherein the control electrode of the transistor is coupled to the output of the operational amplifier, wherein the working electrode of the transistor is coupled to the connection for a DC supply voltage; and
a current measuring resistor which is coupled in series between the reference electrode of the transistor and a reference potential, wherein the voltage dropped across the current measuring resistor is coupled to the inverting input of the operational amplifier;
wherein at least one load is coupled in parallel with the first and second connections for the at least one light emitting diode.

2. The circuit arrangement as claimed in claim 1,
wherein
the load comprises at least one or more of the following elements: ohmic resistor; sink current; and constant current diode.

3. The circuit arrangement as claimed in claim 1,
wherein
the load comprises at least one first partial load and one second partial load, wherein an electronic switch is connected in series to at least the second partial load.

4. The circuit arrangement as claimed in claim 3,
wherein
the circuit arrangement furthermore comprises a micro-controller which is designed to determine the forward voltage of at least one light emitting diode coupled between the first connection and the second connection for the at least one light emitting diode and to control the electronic switch(es) accordingly.

5. The circuit arrangement as claimed in claim 1,
wherein
a feedback network is coupled between the output and the inverting input of the operational amplifier.

6. A method for operating at least one light emitting diode in a circuit arrangement with an operational amplifier with a non-inverting input and an inverting input as well as an output; a desired value predefining apparatus, which is coupled to the non-inverting input of the operational amplifier; a first connection and a second connection for the at least one light emitting diode, wherein the first connection is coupled to a connection for a DC supply voltage; a transistor which is coupled in series with the first and second connections for the at least one light emitting diode and can be operated in an analog manner, wherein the transistor has a control electrode, a reference electrode and a working electrode, wherein the control electrode of the transistor is coupled to the output of the operational amplifier, wherein the working electrode of the transistor is coupled to the connection for a DC supply voltage; and a current measuring resistor which is coupled in series between the reference electrode of the transistor and a reference potential, wherein the voltage dropped across the current measuring resistor is coupled to the inverting input of the operational amplifier;
the method comprising:
Coupling of at least one load in parallel with the first connection and the second connection for the at least one light emitting diode.

7. The method as claimed in claim 6,
wherein
the step of coupling is performed such that as a result a positive current constantly flows through the at least one light emitting diode during operation of the circuit arrangement.
